(19) United States
(12) Patent Application Publication
(10) Pub. No.: US 2004/0251179 A1
(43) Pub. Date: Dec. 16, 2004

(54) Method and system for sequentially ordering objects using a single pass delivery point process

(76) Inventors: Bruce H. Hanson, Endicott, NY (US); J. Edward Roth, Lansdale, PA (US)

Correspondence Address: McGuireWoods LLP, Suite 1800, 1750 Tysons Boulevard, Tysons Corner, McLean, VA, 22102-4215, US

(21) Appl. No.: 10/836,199

(22) Filed: May 3, 2004

Related U.S. Application Data
(63) Continuation-in-part of application No. 10/265,570, filed on Oct. 8, 2002.

(51) Int. Cl. B07C 5/00; G06K 9/00

(52) U.S. Cl. 209/584

(57) ABSTRACT

A method and system using a single pass sequencer having a transport system for transporting the mail pieces to a transport system having a moveable carriage system and a stationary carriage system with a plurality of holders slidable between the moveable carriage system and the stationary carriage system. The plurality of holders hold a mail piece of the mail pieces received from the transport system. The mail pieces are sequenced as they are transported or moved to the stationary carriage from the moveable carriage.

### REFERENCE TO RELATED APPLICATION

This application is a continuation in part application to co-pending U.S. application Ser. No. 10/265,570, filed on Oct. 8, 2002, which is now incorporated by reference herein in its entirety.

### BACKGROUND OF THE INVENTION

1. Field of the Invention

The invention generally relates to a single pass sequencer and process and, in particular, to a system and method for sequencing mail pieces in a single pass to reduce overhead space and costs as well as minimize mail damage.

2. Background Description

The delivery of mail such as catalogs, products, advertisements and a host of other articles have increased exponentially over the years. These mail pieces are known to be critical to commerce and the underlying economy. It is thus critical to commerce and the underlying economy to provide efficient delivery of such mail in both a cost effective and time efficient manner. This includes, for example, arranging randomly deposited mail pieces into a sequential delivery order for delivery to a destination point. By sorting the mail in a sequential order based on destination point, the delivery of mail and other articles can be provided in an orderly and effective manner.

In current sorting processes, optical character recognition systems may be used to capture delivery destination information. A host of feeders and other complex handling systems are then used to transport the mail to a host of bins or containers for sorting and future delivery. To this end, central processing facilities, i.e., United States Postal Service centers, have employed a high degree of automation using bar code readers and/or character recognition to perform basic sorting of articles to be transported to defined geographic regions or to local offices within those regions. It is also known to manually sort mail pieces, but this process is very labor intensive, time consuming and costly.

As to known automated sorting processes, currently, for example, a two pass algorithm process is used as one method for sorting mail based on delivery destination. In this known process, a multiple pass process of each piece of mail is provided for sorting the mail; that is, the mail pieces, for future delivery, are fed through a feeder twice for sorting purposes. In general, the two pass algorithm method requires a first pass for addresses to be read by an optical character reader and assigned a label or destination code. Once the mail pieces are assigned a label or destination code, they are then fed to bins based on one of the numbers of the destination code. The mail pieces are then fed through the feeder a second time, scanned, and sorted based on the second number of the destination code. It is the use of the second number that completes the basis for sorting the mail pieces based on delivery or destination order.

The two pass algorithm method may present some shortcomings. For example, the mail pieces are fed through the feeder twice, which may increase the damage to the mail pieces. Second, known optical recognition systems typically have a reliability of approximately 70%; however, by having to read the mail pieces twice, the rate is multiplied by itself dramatically reducing the read rate and thus requiring more manual operations. That is, the read rate is decreased and an operator may have to manually read the destination codes and manually sort the mail when the scanner is unable to accurately read the destination code, address or other information associated with the mail pieces two consecutive times. Additionally, bar code labeling and additional sorting steps involves additional processing time and sorting machine overhead as well as additional operator involvement. This all leads to added costs and processing times.

It is also known that by using the two pass algorithm method as well as other processing methods, the containers and bins may not be efficiently utilized, thus wasting valuable space. By way of illustrative example, a first bin may not be entirely filled while other bins may be over-filled. In this scenario, the mail pieces are not uniformly stacked within the bins, wasting valuable space, causing spillage or an array of other processing difficulties.

However, U.S. application Ser. No. 10/265,570 solves these problems and provides many advantages over known systems. For example, in U.S. application Ser. No. 10/265,570, a novel single pass system and method has been devised to sort and sequence mail pieces in a single sorting pass, thus eliminating the need for a two pass algorithm and accompanying system. The system and method of U.S. application Ser. No. 10/265,570 minimizes damage to flats, provides a single drop point, as well as increases the overall efficiency by ensuring that “tubs” or other transport containers are efficiently utilized by evenly filling the tubs to a maximum or near maximum level. But, further advances in such system are still possible such as, for example, still further reductions in component parts and use of flooring space.

### SUMMARY OF THE INVENTION

In a first aspect of the invention, a system for sorting objects is provided. The system includes at least one feeding station feeding non-sequenced objects to separate holders extending from a carriage movable in at least one direction. The system further includes a stationary carriage adjacent the moveable carriage and a mechanism for transporting the separate holders with non-sequenced objects therein to the stationary carriage in a delivery point sequence.

In another aspect of the invention, a method includes placing objects separately into separate holders on a moveable carriage and assigning sorting criteria to the separate holders based on each of the objects stored therein. The separate holders are moved, in a delivery point sequence, from the moveable carriage to a position on a stationary carriage based on the sorting criteria. The objects are then in a sequential order on the stationary carriage. The method further includes moving each of the separate holders from the stationary carriage to the moveable carriage, incrementally and in the sequential order as initially on the stationary carriage. The sequenced objects are unloaded from each of the separate holders on the moveable carriage.

In yet another aspect of the invention, the method includes placing non-sequenced mail pieces in separate holders extending from a first carriage and assigning codes to the separate holders and positions on a second carriage based on delivery information associated with the non-sequenced mail pieces. The separate holders are aligned on the first carriage with corresponding positions on the second carriage based on the assigned codes and moved in a sequential order from the first carriage to the second carriage, upon alignment, into a delivery point sequence on the second carriage. The separate holders are moved from the second carriage to the first carriage, in a same sequence as presented on the second carriage.

### BRIEF DESCRIPTION OF THE DRAWINGS

FIG. 1 is an overview of the single pass system utilizing the method of the invention;

FIG. 2 shows a sectional view of adjacent carriages along line 2-2 of FIG. 1;

FIG. 3 shows a holder in accordance with the invention;

FIG. 4 shows a latch used with the holder;

FIGS. 5a-5c are flow charts implementing the steps of the invention using the system of the invention;

FIGS. 6a-6e show several operational phases of the system in accordance with the invention; and

FIG. 7 shows a diagrammatic representation of the method of the invention.

### DETAILED DESCRIPTION OF EMBODIMENTS OF THE INVENTION

The invention provides a flexible system and method for sequencing objects such as, for example, flats, mail pieces and other products or parts (generally referred to as flats or mail pieces) in a mixed stream process using only a single feed or pass through a feeder system. The system and method of the invention reduces damage to flats by using a single pass, and reduces manufacturing and delivery costs while still maintaining superior sorting and delivery results. For example, in one aspect of the invention, overall length and working components can be considerably reduced conserving valuable user floor space and costs by using a stationary storage carriage. The system configuration is also variable to adapt to facility size, in terms of number of routes and size of routes.

### Embodiments of the Single Pass Sorting System

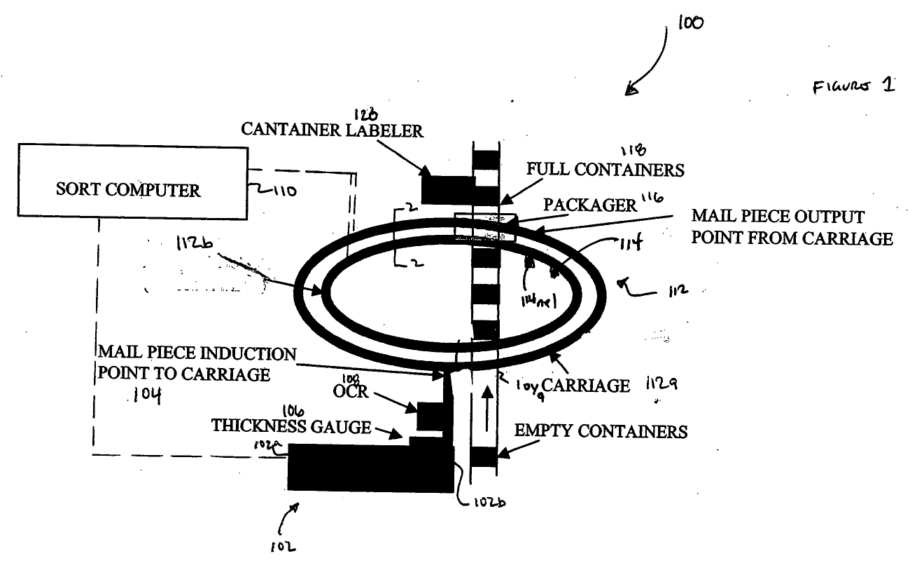

FIG. 1 depicts a single pass system that utilizes the method of the invention. The system is generally depicted as reference numeral 100 and includes one or more feeders 102 positioned at a beginning of the process. The feeder(s) 102 may be any known feeder that is capable of transporting flats from a first end 102a to a second, remote end 102b. In embodiments, the feeder(s) 102 is capable of feeding the stream of flats at a rate of approximately 10,000 per hour. Of course, those of skill in the art should recognize that other feed rates and multiple feeders, depending on the application, might equally be used with the invention.

Still referring to FIG. 1, a transport system or feed track 104 is positioned downstream from the feeder(s) 102, and preferably at an approximate 90° angle therefrom. This angle minimizes the use of valuable flooring space within the processing facility. The feed track 104 may also be at other angles or orientations, depending on the flooring configuration of the processing facility.

A flat thickness device 106 and a scanning device 108 such as, for example, an optical character recognition device (OCR), bar code scanner or the like is provided adjacent or proximate the feed track 104. In embodiments, the flat thickness device 106 measures the thickness of each flat as it passes through the system, and the OCR 108 reads the address or other delivery information which is located on the flat. The flat thickness device 106 may be any known measuring device such as a shaft encoder, for example. The flat thickness device 106 and the OCR 108 communicate with a sorting computer 110 via an Ethernet, Local Area Network, Wide Area Network, Intranet, Internet or the like. The flat thickness device 106 and the OCR 108 provide the thickness and address information to the sort computer 110, at which time the sort computer 110 assigns a virtual code to the flat for delivery and sorting purposes. This is provided via a look-up table or other known method.

In one particular application, for illustration, the OCR 108 will capture information such as, for example, address destination information, from the flats. Once the information is captured, it will be sent to the central processing unit (e.g., sorting computer 110) for interpretation and analysis. Using this information, the sorting computer can provide instructions to any the components of the invention for sequencing the flats, as discussed in more detail below.

FIG. 1 further shows a cell movement mechanism 112 in accordance with the invention, at a remote end 104a of the feed transport 104. The cell movement mechanism 112 may be any shape such as an oval shape shown in FIG. 1, or other shapes such as, for example, a loop configuration, e.g., circular, serpentine and the like, in line or other shapes that are designed for certain flooring spaces. In one embodiment, the overall track may be any length, but in one implementation the track may be a diameter of approximately 25 feet. Multiple systems may also be nestable; namely, the system of the invention may be stacked vertically to more efficiently utilize the flooring space of the processing facility.

The cell movement mechanism 112 includes a first, moveable carriage 112a and a second, stationary carriage 112b (referred hereinafter as the “stationary carriage”). The stationary carriage 112b eliminates the need for additional motors and other hardware, otherwise needed to move such a carriage thus reducing overhead costs and flooring space. The first carriage 112a may transport the flats in one direction (e.g., when in a loop configuration) or bi-directionally (e.g., when in a line configuration). In one aspect of the invention, a plurality of holders or cartridges 114, 114ₙ₊₁ extend downward from the first carriage 112a or the stationary carriage 112b, depending on the particular stage of the process.

In one implementation, the sort computer 110 tracks each holder in addition to the flats loaded therein, and assigns numerical designations, codes or the like corresponding to the order of the holders 114 on the first carriage 112a or the designations associated with the flats placed therein (as discussed below). In this manner, the sort computer 110 is capable of accurately following each flat throughout the system for future sorting.

FIG. 1 further shows an optional packager 116 at a certain predetermined position with respect to the cell movement mechanism 112, and preferably aligned with the first carriage 112a. (Those of skill in the art will recognize that multiple packagers can also be used with the invention.) The packager 116 is designed to package the flats as they are unloaded from the first carriage 112a, via a releasable bottom portion of the holders 114. The packager 116 then transports the flats to containers 118 that are provided with a label at container labeler 120. In embodiments and due to the tracking of the thickness of each flat, the system of the invention is capable of determining the height of the flats in each container 118 thus ensuring maximum use of each container.

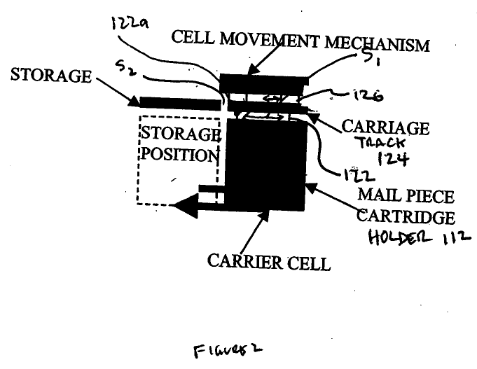

FIG. 2 shows a sectional view of the cell movement mechanism along line 2-2 of FIG. 1. In this view, the holder 114 extends downward from the first carriage 112a, with a transporting mechanism, allowing the holder 114 to move, e.g., slide or roll, between the first carriage 112a and the stationary carriage 112b. In one aspect of the invention, the transporting mechanism includes “hangers” 122, suspended from a bar or track 124, which allow the holders to suspend and slide between respective carriages. In one embodiment, the hangers may include wheels or bearings, depicted as reference numeral 122a, instead of a “hooked” portion. (The hooked portion, provided about the track, may also be depicted as reference numeral 122a.) The wheels or bearings facilitate the movement of the hangers 122 and hence the holders 114 between the tracks of the carriages. Such components of hangers are manufactured by Timken Company of Canton Ohio, for example, and are used by Lockheed Martin Corporation.

The hangers 122 may be transported by sliding between the first carriage and the stationary carriage by known mechanisms such as, for example, linear actuators, solenoids or piston and cylinder assemblies, as depicted at reference numeral 126. The linear actuators, solenoids or piston and cylinder assemblies may be packaged in the cell movement mechanism 112 and communicate with the holders and, in one application, directly with the hangers, themselves. The linear actuators, solenoids or piston and cylinder assemblies push or pull the hangers, depending on the position between the respective carriages. Such linear actuators, solenoids or piston and cylinder assemblies are manufactured by Tol-o-matic Fluid Power Products of Hamel Minn., for example, and are implemented in various applications by Lockheed Martin Corporation. The hangers 122 may also simply be manually moved, although less efficient than an automated means of moving the carriages.

As further shown in FIG. 2, in one aspect of the invention, the spacing S₁ between the hangers 122 for each of the holders 114 may be larger than the spacing S₂ between the first carriage 112a and the stationary carriage 112b. This will allow the holders 114 and more specifically the hangers 122 of each of the holders 114 to span the gap between the tracks of the aligned carriages 112a and 112b, ensuring the stability of the system. Said otherwise, the hangers 122 are designed to allow them to span or bridge the gap or space between the carriages 112a and 112b thus ensuring that the hangers are always stably “hooked” to one of the carriages 112a and 112b.

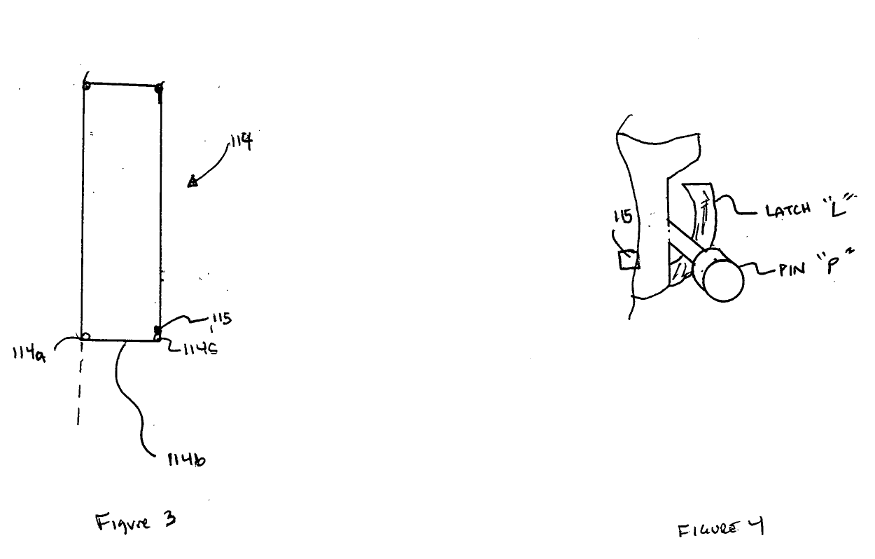

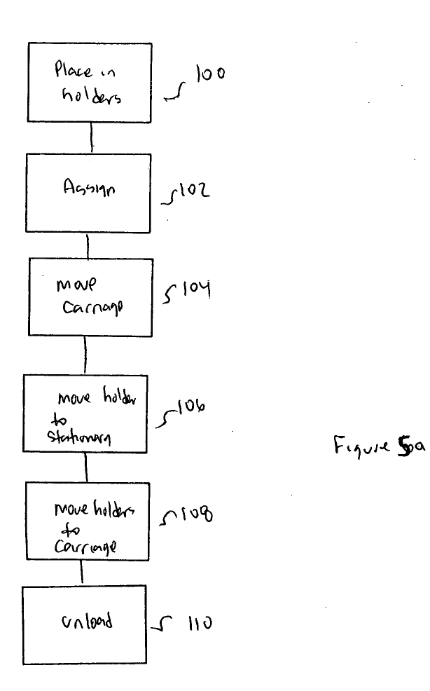

FIG. 3 shows a holder 114 in accordance with the invention. In one implementation, the holder 114 may have a maximum width of approximately two inches and is a box-shape. The holder 114 includes, in one aspect of the invention, a hinge 114a provided on a bottom corner of the holder 114. A drop down or releasable bottom 114b may be provided between the hinge 114a and a releasable latch 144c in order unload the flats from the holder to the packager or directly into the container, for example. To release the bottom 114b, an actuator 115 may be actuated which releases the latch 114c, for example. The actuator may be a solenoid, or a hydraulic or pneumatic mechanism. The latch may be, for example, a pin “P and latch “L” assembly (FIG. 4). In this type of assembly, the latch “L” is moveable to release the pin “P” in order to drop the bottom portion 114b.

### Operation of Use

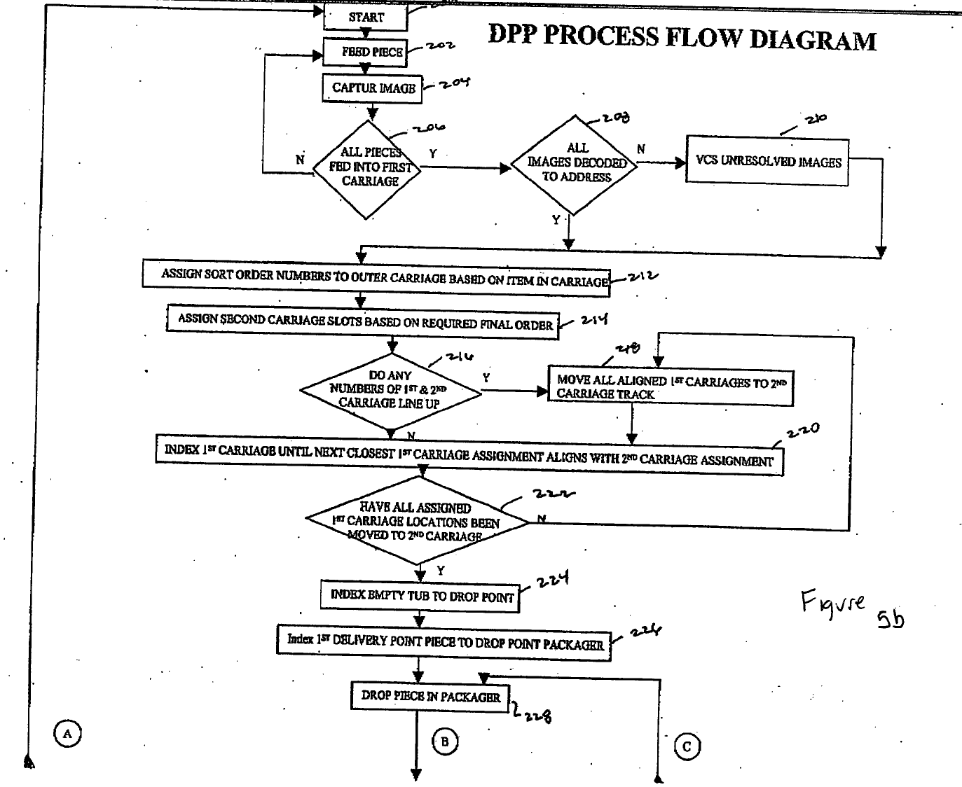

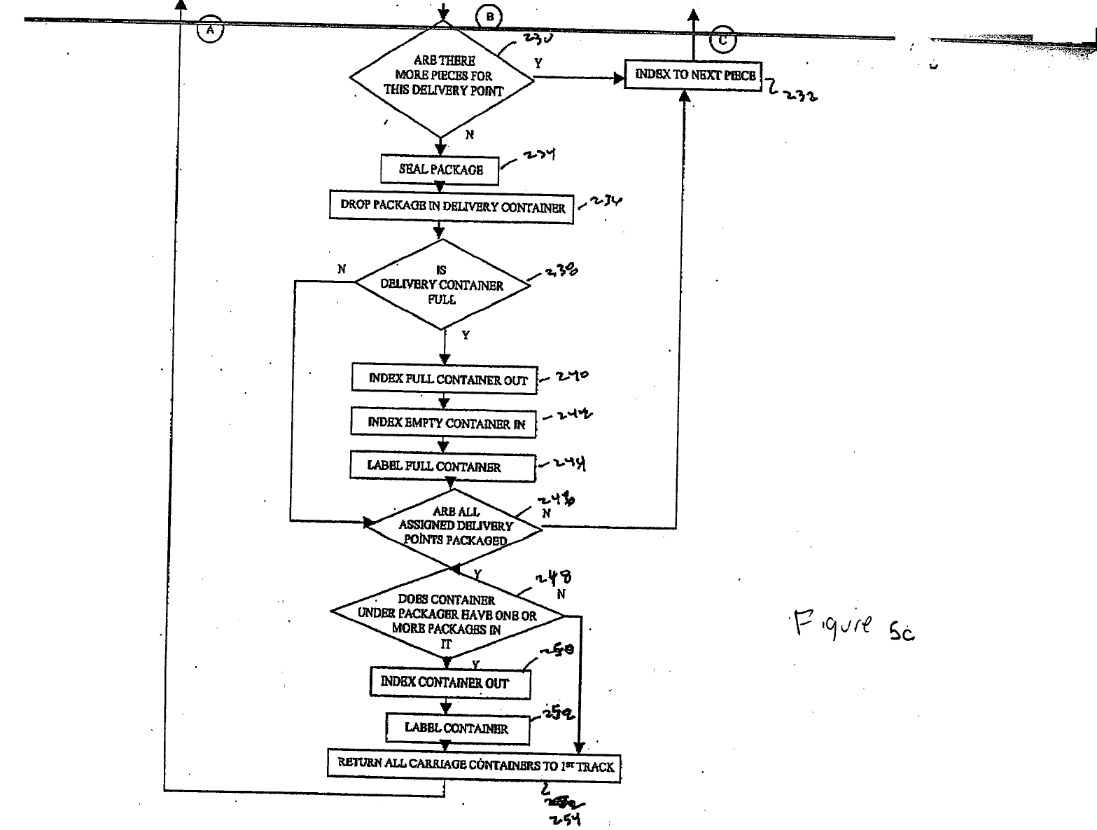

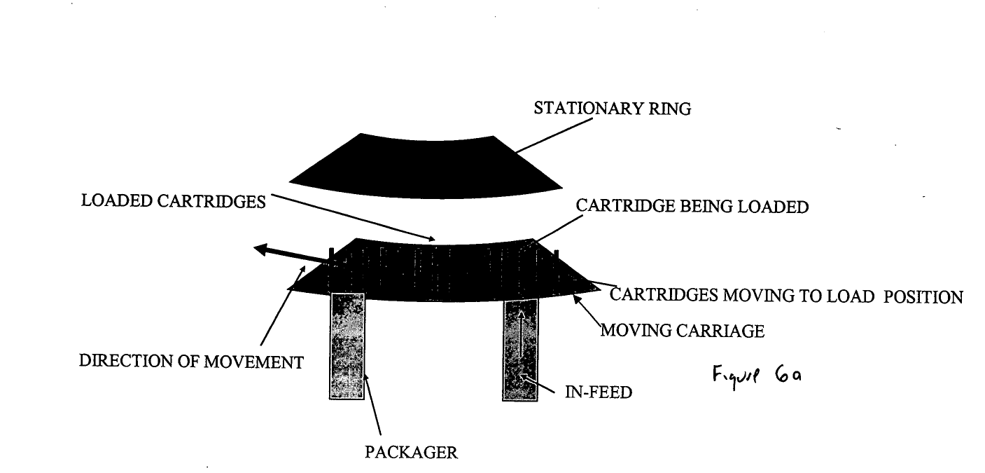

FIGS. 5a-5c are flow diagrams showing the steps implemented by the invention. The steps of the invention may be implemented on computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Additionally, the computer program code can be transferred to a workstation or the sort computer over the Internet or some other type of network. FIGS. 5a-5c may equally represent a high-level block diagram of the system of the present invention, implementing the steps thereof.

FIG. 5a is an embodiment implementing the steps of the invention. In step 100, the non-sequenced flats are placed in the holders extending from the first carriage. In step 102, the sort computer assigns codes or the like to the holders and positions on the carriage(s) based on the flat information and sequencing thereof. In step 104, the carriage 112a, incrementally moves and is aligned with corresponding positions on the stationary carriage 112b. In step 106, the holders are moved from the carriage to the stationary carriage, in sequence. Steps 104 and 106 may repeated until all of the holders carrying flats for a delivery route, for example, are on the stationary carriage in a delivery order sequence. In step 108, the holders are moved back to the carriage from the stationary carriage, in the delivery order as they were on the stationary carriage. It should be understood that the ordering of the flats, in the delivery order sequence, may occur when the holders are moved onto the moveable carriage 112a from the stationary carriage 112b based on the codes assigned to the holders and positions on the respective carriages, as determined by the sort computer. In step 110, the flats are sequentially loaded into the packager or directly into containers.

Referring now to FIGS. 5b and 5c, in step 200, the control begins. In step 202, a piece of mail or other product or part (referred hereinafter as a flat), in no particular order or sequence, is fed into the system. In step 204, the image of the flat is captured, which preferably includes the address information. In step 206, a determination is made as to whether all of the flats are fed into the holders of the first carriage. If yes, a determination is made, in step 208, as to whether all of the images are decoded to address. If not, then all unresolved images are resolved in step 210. Once all of the images are resolved or decoded, then a sort number or code (i.e., sorting criteria) is assigned to each of the holders of the first carriage based on the specific flat in the holder (step 212) (or, in embodiments, the order of the holders, themselves). In step 214, a number or code (i.e., a final order sorting information also referred to as a number or code) is assigned to the slots or unused spaces on the stationary carriage based on the final order of delivery of the flat. These slots will eventually accommodate the holders, as discussed below, in sequence. In step 216, a determination is made as to whether any of the numbers or codes assigned to the holders of the first carriage aligns with the numbers or codes assigned to the slots of the stationary carriage. If yes, then, in step 218, all of such aligned holders are moved from the first carriage to the stationary carriage position.

If there are no alignments then, in step 220, the first carriage is indexed until at least one assigned number or code associated with the holder on the first carriage is aligned with an assigned number or code of the stationary carriage. The indexing is preferably a single, incremental turn of the first carriage in either the clockwise or counter clockwise direction. Next, in step 222, a determination is made as to whether all of the assigned numbers associated with the holders in the first carriage have been moved to the appropriate locations on the stationary carriage. If not, steps 218 and 220 are repeated. If yes, then the holders are moved to the first carriage in the same order as they were on the stationary carriage, and an empty container or tub is indexed to the drop point, in step 224, preferably below a point associated with the first carriage. In step 226, the first carriage is indexed so the first delivery point is over the drop point for packaging (referred to as the packager point). The flat is then dropped in the optionally in the container or packager in step 228.

In step 230, a determination is made as to whether there are additional flats for dropping into the packager for the particular delivery point. If there are additional flats then, in step 232, the system is indexed and steps 228 and 230 are repeated. If there are no additional flats, then, in embodiments, the flats are sealed as a package in step 234. The package is then dropped in a delivery container in step 236.

Still referring to FIGS. 5b and 5c, in step 238, a determination is made as to whether the delivery container is full. This might be performed by first measuring the thickness of the flats placed in the delivery container, prior to the placement thereof. If the delivery container is full, then the fill delivery container is indexed to a next position in step 240. In step 242, a next delivery container is indexed to the package drop point and, in step 244, the full container is labeled. Of course, these steps do not necessarily have to occur in such order.

If the determination in step 238 is negative or after step 244, a determination is made as to whether all assigned flats for all delivery points are packaged (step 246). If not, then the method returns to step 232. If so, then a determination is made as to whether the delivery container has at least one or more flats, in step 248. If yes, then the delivery container is indexed out (step 250) and labeled (step 252). Then a new container is provided to the first carriage or packager, in step 254, in order to continue the filling process. The process will then begin again in step 200.

### Example of Use

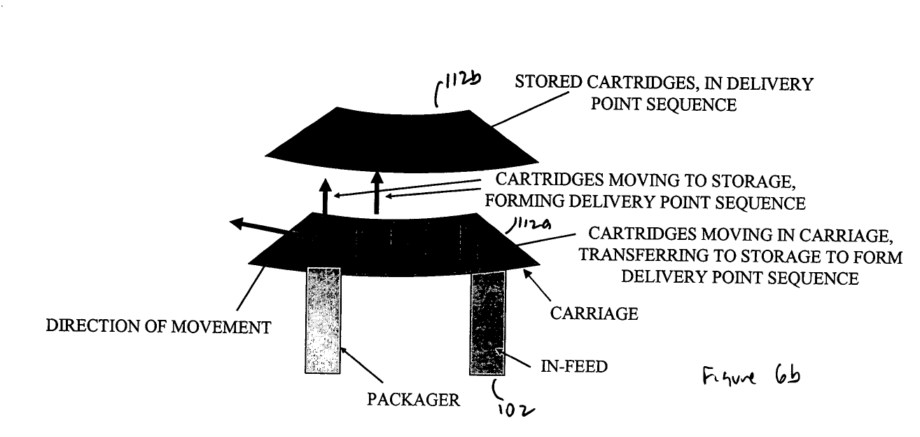

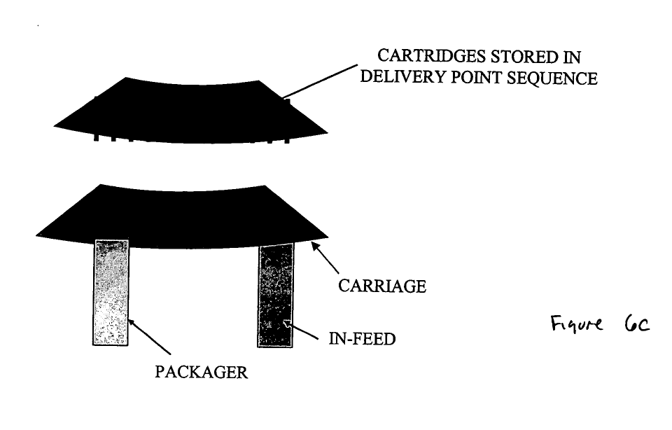

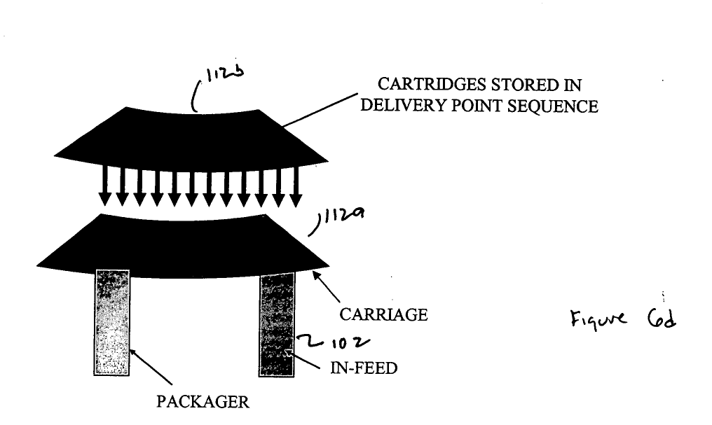

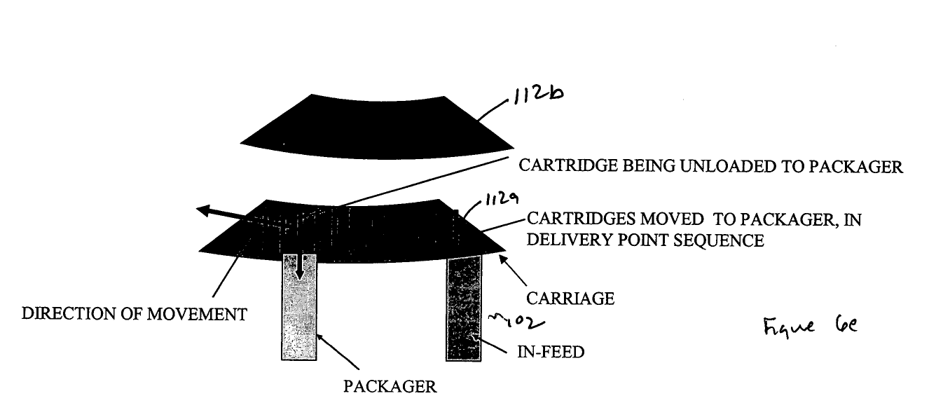

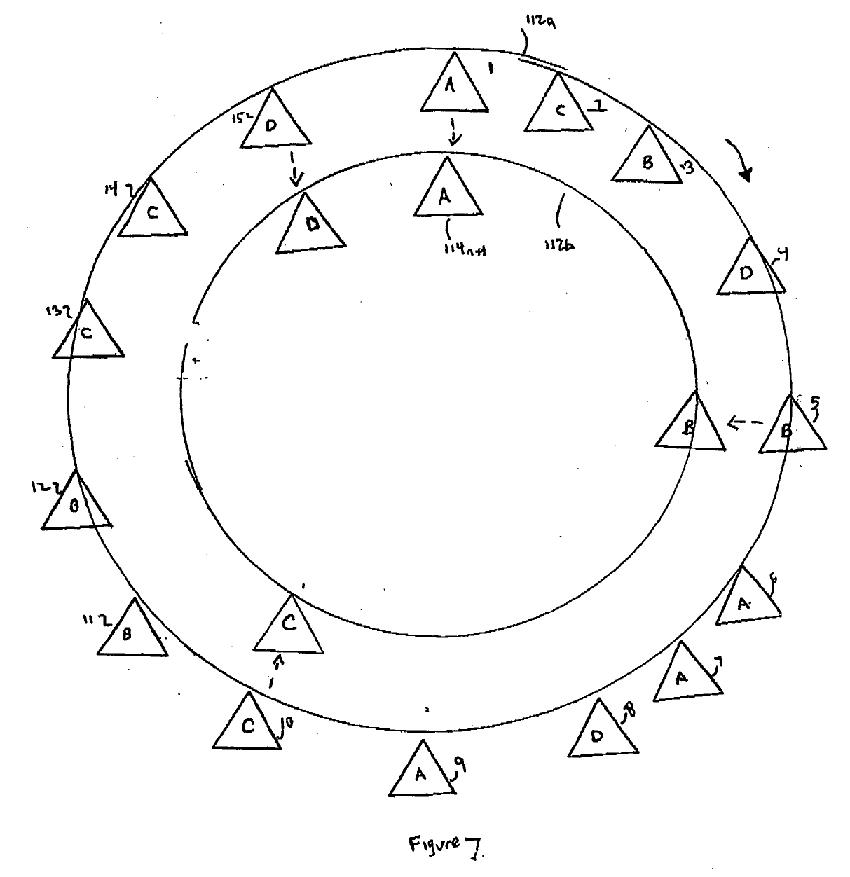

Referring to FIGS. 6a-6e, an example is illustrated showing the operational stages of the invention. In this example, used for illustrative purposes only and not to limit the scope of the invention, the stream of flats are first fed through the automated feeder 102 at approximately 10,000 per hour. In the feed track or feeder, the flat image is acquired by the OCR 108 and decoded for its destination information (a code is assigned thereto). In addition, mail thickness information is acquired at the flat thickness device 106. The destination and thickness information is stored in the sort computer 110, preferably within a database.

In one implementation, each holder 114, on the first carriage 112a, is assigned a sequential number for sorting purposes. The stationary carriage 112b is also assigned numbers or codes corresponding to the sequential order of the final completed sort. That is, the order of the holders 114 on the first carriage 112a are sequentially assigned a number or code by the sort computer 110; whereas, a number or code is assigned to a position on the stationary carriage 112b associated with a delivery destination of each of the flats.

As represented by FIG. 6a, the non-sequenced flats are inducted into the holders 114, located on the moving carriage 112a, as the holders 114 move serially past each feed station. The first carriage 112a is incremented (one by one) so all the holders can be filled as they pass the feeders. During this operational stage, the information on the flats is read by the OCR and computations are provided by the controller to assign a sequential number or codes corresponding to the sequential order of the final completed sort.

Referring to FIG. 6b, as the first carriage 112a is incremented (one by one), the assigned numbers align between the first carriage 112a and the stationary carriage 112b. As the numbers align during this incrementing process, as determined by the sort computer 110, each holder 114 is moved from the first carriage 112a to the stationary carriage 112b until all of the flats are in sequential order for delivery on the stationary carriage 112b as shown in FIG. 6c. In one implementation, all holders 114 that contain flats will be moved from the first carriage 112a to the stationary carriage 112b within one complete revolution.

Referring to FIG. 6d, following the holders being placed in sequence on the stationary carriage, the holders will then be transported back to the first carriage 112a, in sequence. This may be performed by transferring each holder to the first carriage, without any movement of the first carriage. In FIG. 6e, all of the flats are then discharged from the first carriage into the packager. That is, during this operational phase, as each holder 114 approaches its assigned packager (according to delivery sequence segment), the holder 114 will drop the flats via the latched mechanism.

FIG. 7 shows a diagrammatic representation of the above operational stages of the invention and is provided for illustrative purposes only. FIG. 7 shows the first and stationary carriages 112a and 112b with respective flats placed in holders 114ₙ₊₁. Initially, the holders 114ₙ₊₁ are positioned on the first carriage 112a, each being assigned a sequential number 1-15, for example. The sort computer 110 tracks the holders 1-15 and the flats (designated “A” through “D” based on delivery destination). Once the holders 114ₙ₊₁ are filled, the sort computer 110 determines whether any numbers assigned between the first and stationary carriage 112a and 112b are aligned. If so, then these holders are moved from the first carriage to the stationary carriage 112b. In the example of FIG. 3, the 1^{st}, 5^{th}, 10^{th} and 15^{th} holders of the first carriage 112a are initially aligned and moved to the stationary carriage 112b.

The first carriage 112a is then rotated, and the determination of alignment and movement is then performed again. The next alignment would be at the 3^{rd} incremental alignment where at least the 3^{rd} holder (“B” destination flat) would be aligned with the sixth place in the stationary carriage 112b. At this time, the 3^{rd} holder would be moved to the stationary carriage 112b. This process continues until all of the holders in the first carriage 112a are moved to the stationary carriage 112b, in the delivery order (i.e., all “A” though “D” delivery destinations are each grouped together and hence aligned sequentially). As now should be understood, the sort computer 110, while keeping track of all of the holders 114 and the contents therein, makes the determination of when to move the holders 114 from the first carriage 112a to the stationary carriage 112b for delivery sequencing. Once in the proper sequence, the holders on the stationary carriage 112b are then sequentially or simultaneously moved to the first carriage and the contents in the holders 114 are loaded into the containers or packager, as described above.

While the invention has been described in terms of embodiments, those skilled in the art will recognize that the invention can be practiced with modifications and in the spirit and scope of the appended claims.

1. A system for sorting objects, comprising:
at least one feeding station feeding non-sequenced objects to separate holders extending from a carriage movable in at least one direction;
a stationary carriage adjacent the moveable carriage; and
a mechanism for transporting the separate holders with non-sequenced objects therein to the stationary carriage in a delivery point sequence.

2. The system of claim 1, wherein the separate holders include a releasable latch mechanism.

3. The system of claim 2, further comprising an actuator for disconnecting the releasable latch mechanism at a predetermined time or location.

4. The system of claim 1, further comprising a mechanism for attaching each of the separate holders to the moveable carriage and the stationary carriage.

5. The system of claim 1, wherein the transporting mechanism transports each of the separate holders between the moveable carriage and the stationary carriage via sliding or rolling.

6. The system of claim 1, wherein the moveable carriage is movable in two directions for loading of the non-sequenced objects and unloading of the objects, in the delivery point sequence.

7. The system of claim 1, wherein the objects are mail pieces.

8. The system of claim 1, further comprising one or more packagers downstream from the moveable carriage, wherein the objects are unloaded from the separate holders on the moveable carriage, in the delivery sequence, to the one or more packagers.

9. The system of claim 1, further comprising a reading device and control, the reading device reading information on the objects and delivering the information to the control which assigns sort codes to the separate holders and positions on the stationary carriage based on the information, the control further instructing the movement of the moveable carriage, incrementally, and the mechanism for transporting the separate holders to the stationary carriage in the delivery sequence.

10. A method of sorting, comprising the steps of:
inducting objects separately into separate holders on a moveable carriage and assigning sorting criteria to the separate holders based on each of the objects within each of the separate holders;
moving the separate holders, in a delivery point sequence, from the moveable carriage to respective positions on a stationary carriage based on the sorting criteria, thereby placing the objects in a sequential order on the stationary carriage;
moving each of the separate holders from the stationary carriage to the moveable carriage, incrementally or simultaneously and in the sequential order as on the stationary carriage; and
unloading the sequenced objects from each of the separate holders on the moveable carriage.

11. The method of claim 10, further comprising the step of instructing the moveable carriage to incrementally rotate in order to align each of the separate holders with corresponding empty positions on the stationary carriage based on the sorting criteria of the objects and the corresponding empty positions to thereby place the objects in the separate holders in the sequential order on the stationary carriage.

12. The method of claim 10, wherein the objects are mail pieces.

13. The method of claim 10, further comprising placing a packager or packagers at a predetermined position with respect to the moveable carriage such that the objects are unloaded from each of the separate holders on the moveable carriage in the sequential order into the packager or packagers.

14. The method of claim 10, further comprising loading the objects into the separate holders on the moveable carriage concurrently with the unloading of the objects that are in the sequential order.

15. The method of claim 10, wherein the sorting criteria step includes assigning codes to the separate holders and positions on the stationary carriage based on delivery information associated with the objects.

16. A method of sequencing objects, comprising:
placing non-sequenced mail pieces in separate holders extending from a first carriage;
assigning codes to the separate holders and positions on a second carriage based on information associated with the non-sequenced mail pieces;
aligning the separate holders on the first carriage with corresponding positions on the second carriage based on the assigned codes; and
moving in a sequential order the separate holders from the first carriage to the second carriage, upon alignment, into a delivery point sequence on the second carriage;
moving the separate holders from the second carriage to the first carriage, in a same sequence as presented on the second carriage.

17. The method of claim 16, wherein the mail pieces within the separate holders are incrementally moved to be placed in sequence on the stationary carriage.

18. The method of claim 16, wherein:
the first carriage incrementally moves prior to moving the separate holders from the first carriage to the second carriage into the delivery point sequence,
the first carriage remains stationary during the moving of the separate holders from the first carriage to the second carriage, and
the first carriage remains stationary during the moving of the separate holders from the second carriage to the first carriage.

19. The method of claim 16, wherein the first carriage remains stationary when the holders are moved in the same sequence from the second carriage to the first carriage.

20. The method of claim 16, wherein the assigning step is performed previous to the alignment step.

21. The method of claim 16, wherein the aligning step includes moving at least one of the separate holders on the first carriage to a position in alignment with an empty position on the second carriage prior to moving the first carriage.
